(19) United States
(12) Patent Application Publication
(10) Pub. No.: US 2019/0299098 A1
(43) Pub. Date: Oct. 3, 2019

(54) METHODS, SYSTEMS, APPARATUSES AND DEVICES FOR COLLECTING SUBJECTIVE PREFERENCES FROM USERS USING GAMIFICATION

(71) Applicant: Mihir Parikh, Sonoma, CA (US)

(72) Inventor: Mihir Parikh, Sonoma, CA (US)

(21) Appl. No.: 16/374,445

(22) Filed: Apr. 3, 2019

Related U.S. Application Data
(60) Provisional application No. 62/651,952, filed on Apr. 3, 2018.

(51) Int. Cl. A63F 13/533; H04L 29/08; A63F 13/40; A63F 13/235; A63F 13/46; A63F 13/212; A63F 13/27; A63F 13/61

(52) U.S. Cl. CPC A63F 13/533; H04L 67/306; A63F 13/40; A63F 13/235; H04W 88/02; A63F 13/212; A63F 13/27; A63F 13/61; A63F 13/46

(57) ABSTRACT

A system for collecting subjective preferences from users using gamification is disclosed. The system may include a communication device configured for transmitting at least one prompt to at least one presentation device, receiving a plurality of responses from at least one input device associated with a plurality of users, and transmitting indication of the at least one winner to the at least one presentation device. Further, the system may include a processing device configured for analyzing the plurality of responses, calculating a metric associated with the plurality of users based on the analyzing, assigning a plurality of scores to the plurality of users, and determining at least one winner based on the scoring. Further, the system may include a storage device configured for storing the plurality of responses in association with a plurality of identifiers associated with the plurality of users.

The current application claims a priority to the U.S. Provisional Patent application Ser. No. 62/651,952 filed on Apr. 3, 2018.

### FIELD OF THE INVENTION

Generally, the present disclosure relates to the field of data processing. More specifically, the present disclosure relates to methods, systems, apparatuses and devices for collecting subjective preferences from users using gamification.

### BACKGROUND OF THE INVENTION

Food and beverage tasting/consumption events are becoming popular across the world. These events may be held in public spaces such as parks, or they may be held in private spaces such as restaurants, wine bars or even at homes. The food tasting events allow the participants to taste various types of food products. The participants may like some food products and they may not like some other food items. These individual tasting preferences may provide useful feedback to the food providers. However, the individual tasting preferences are not generally recorded, accurately and in real-time.

Therefore, there is a need for improved methods, systems, apparatuses and devices for collecting subjective preferences from users using gamification that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of collecting subjective preferences from users using gamification. The method may include transmitting, using a communication device, at least one prompt to at least one presentation device configured for presenting the at least one prompt. Further, the at least one prompt may be associated with at least one sensory experience deliverable to a plurality of users. Further, the method may include receiving, using the communication device, a plurality of responses from at least one input device associated with the plurality of users. Further, the plurality of responses represents subjective experiences of the plurality of users to the at least one sensory experience. Further, the method may include analyzing, using a processing device, the plurality of responses. Further, the method may include calculating, using the processing device, a metric associated with the plurality of users based on the analyzing. Further, the method may include assigning, using the processing device, a plurality of scores to the plurality of users based on a comparison of the plurality of responses with the metric. Further, the method may include determining, using the processing device, at least one winner based on the scoring. Further, the method may include transmitting, using the communication device, indication of the at least one winner to the at least one presentation device. Further, the method may include storing, using a storage device, the plurality of responses in association with a plurality of identifiers associated with the plurality of users.

Further disclosed herein is a system for collecting subjective preferences from users using gamification. The system may include a communication device configured for transmitting at least one prompt to at least one presentation device configured for presenting the at least one prompt. Further, the at least one prompt may be associated with at least one sensory experience deliverable to a plurality of users. Further, the communication device may be configured for receiving a plurality of responses from at least one input device associated with the plurality of users. Further, the plurality of responses represents subjective experiences of the plurality of users to the at least one sensory experience. Further, the communication device may be configured for transmitting indication of the at least one winner to the at least one presentation device. Further, the system may include a processing device configured for analyzing the plurality of responses. Further, the processing device may be configured for calculating a metric associated with the plurality of users based on the analyzing. Further, the processing device may be configured for assigning a plurality of scores to the plurality of users based on a comparison of the plurality of responses with the metric. Further, the processing device may be configured for determining at least one winner based on the scoring. Further, the system may include a storage device configured for storing the plurality of responses in association with a plurality of identifiers associated with the plurality of users.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a system for collecting subjective preferences from users using gamification, in accordance with some embodiments.

FIG. 3 is a flowchart of a method of collecting subjective preferences from users using gamification, in accordance with some embodiments.

FIG. 4 is a flowchart of a method to facilitate assigning a score, in accordance with further embodiments.

FIG. 5 is a flowchart of a method to facilitate providing promotional content, in accordance with further embodiments.

FIG. 6 is an exemplary schematic related to a tasting or consumption event, in accordance with an exemplary embodiment.

FIG. 7 is a schematic related to a wine tasting event, in accordance with an exemplary embodiment.

FIG. 8 is an exemplary representation of a note card presented to a user at a wine tasting event, in accordance an exemplary embodiment.

FIG. 9 is an exemplary representation of a deviation scorecard, in accordance with some embodiments.

FIG. 10 is an exemplary representation of a winner card, in accordance with some embodiments.

FIG. 11 is an exemplary representation of a guess scorecard, in accordance with some embodiments.

FIG. 12 is an exemplary representation of a winner card showing points earned by winners, in accordance with some embodiments.

FIG. 13 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of collecting subjective preferences from users using gamification, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

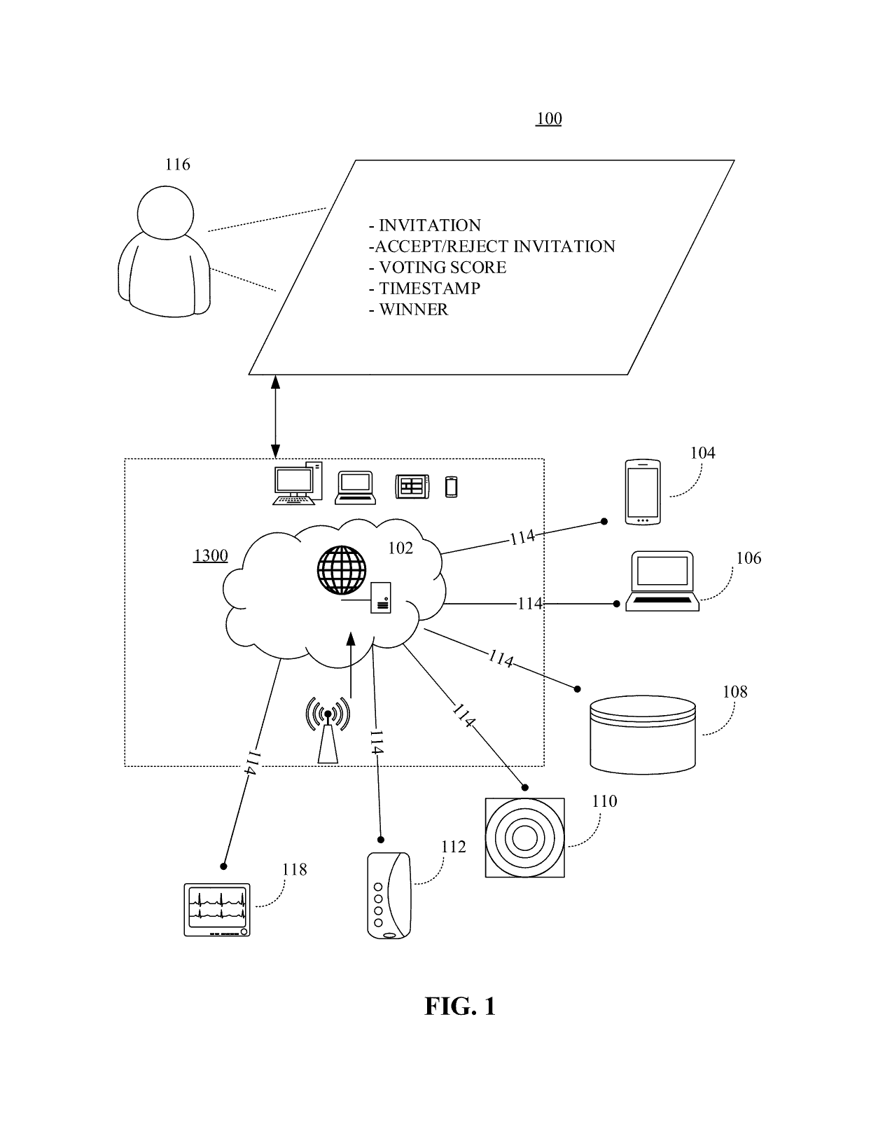

FIG. 1 is an illustration of an online platform 100 consistent with various embodiments of the present disclosure. By way of non-limiting example, the online platform 100 to facilitate collecting subjective preferences from users using gamification may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, physiological sensors 118, wireless keypads 112, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access the online platform 100 through a web based software application or browser. The web based software application may be embodied as, for example, but not be limited to, a website, a web application, a desktop application, and a mobile application compatible with a computing device 1300.

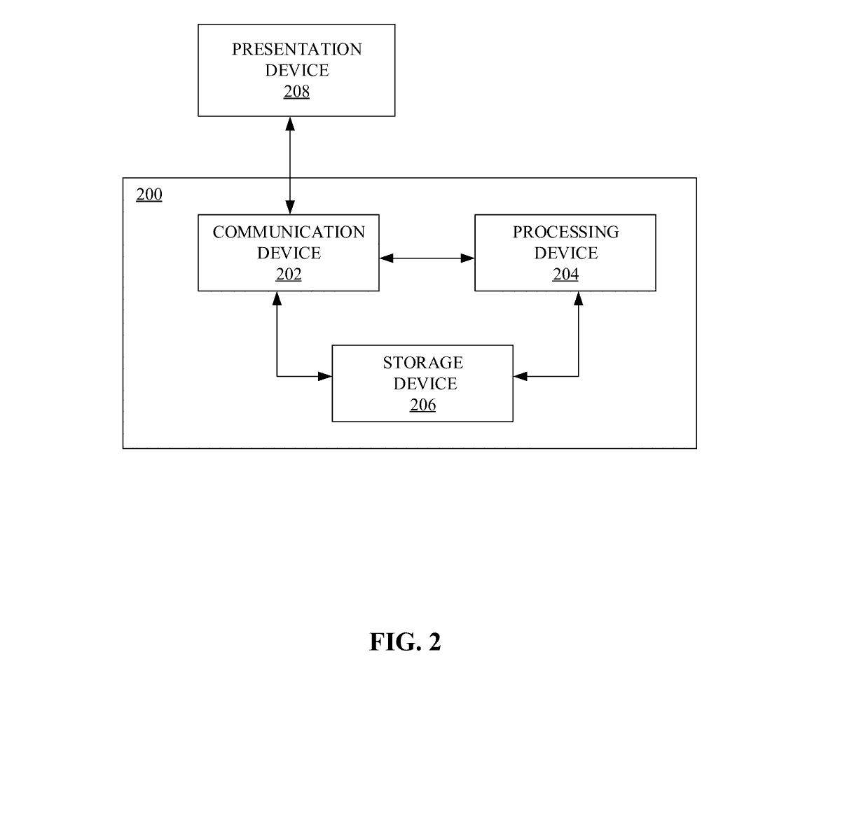

FIG. 2 is a system 200 for collecting subjective preferences from users using gamification, in accordance with some embodiments. Accordingly, the system 200 may include a communication device 202 configured for transmitting at least one prompt to at least one presentation device 208 configured for presenting the at least one prompt. Further, the at least one prompt may be associated with at least one sensory experience deliverable to a plurality of users. In some embodiments, the at least one presentation device 208 may include a public presentation system. Further, in some embodiments, the at least one presentation device 208 may include a plurality of user devices associated with the plurality of users. The at least one presentation device 208, in an instance, may include, but may not be limited to, a television (TV), a laptop, a smartphone, a smartwatch etc.

Further, the communication device 202 may be configured for receiving a plurality of responses from at least one input device associated with the plurality of users. Further, the plurality of responses may represent subjective experiences of the plurality of users to the at least one sensory experience. In some embodiments, the plurality of responses may include a plurality of numerical data. Further, in some embodiments, the at least one input device may include a public input system. Further, in some embodiments, the at least one input device may include a plurality of user devices associated with the plurality of users. Further, in some embodiments, the at least one input device may include a plurality of wireless keypads associated with the plurality of users.

Further, the communication device 202 may be configured for transmitting indication of the at least one winner to the at least one presentation device 208.

Further, the system 200 may include a processing device 204 configured for analyzing the plurality of responses.

Further, the processing device 204 may be configured for calculating a metric associated with the plurality of users based on the analyzing. In some embodiments, the metric may include one or more of an average, a mean, a mode, an interquartile mean, a median, a standard deviation, a skewness and a kurtosis.

Further, the processing device 204 may be configured for assigning a plurality of scores to the plurality of users based on a comparison of the plurality of responses with the metric.

Further, the processing device 204 may be configured for determining at least one winner based on the scoring.

Further, the system 200 may include a storage device 206 configured for storing the plurality of responses in association with a plurality of identifiers associated with the plurality of users.

In some embodiments, the system 200 may further include receiving a plurality of physiological responses from at least one physiological sensor (such as the physiological sensor 118) comprised in the at least one input device. Further, the at least one physiological sensor may be configured for sensing the plurality of physiological responses associated with the plurality of users corresponding to at least one time corresponding to the delivery of the at least one sensory experience.

In some embodiments, the processing device 204 may be further configured for calculating a similarity measure between a response of the plurality of responses associated with a user and the metric. Further, the processing device 204 may be configured for assigning a score to the user based on the similarity measure. Further, determining the at least one winner may include identifying a maximum score among the plurality of scores. Further, the maximum score corresponds to the at least one winner.

In some embodiments, the processing device 204 may be further configured for identifying promotional content based on a response of the plurality of responses associated with a user of the plurality of users. Further, the processing device 204 may be configured for determining a contact information associated with the user. Further, the communication device 202 may be configured for transmitting the promotional content to a user device associated with the user based on the contact information.

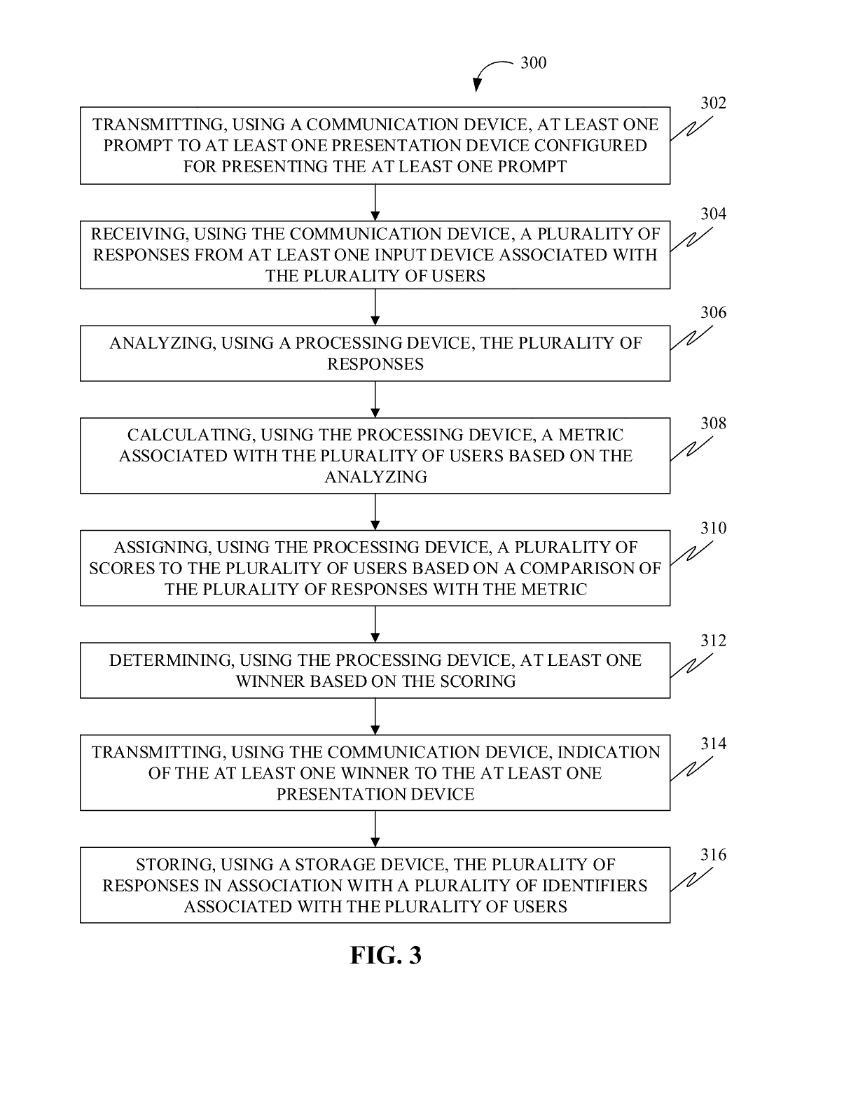

FIG. 3 is a flowchart of a method 300 of collecting subjective preferences from users using gamification, in accordance with some embodiments. Accordingly, at 302, the method 300 may include transmitting, using a communication device (such as the communication device 202), at least one prompt to at least one presentation device (such as the presentation device 208) configured for presenting the at least one prompt. Further, the at least one prompt may be associated with at least one sensory experience deliverable to a plurality of users. In some embodiments, the at least one presentation device may include a public presentation system. Further, in some embodiments, the at least one presentation device may include a plurality of user devices associated with the plurality of users.

Further, at 304, the method 300 may include receiving, using the communication device, a plurality of responses from at least one input device associated with the plurality of users. Further, the plurality of responses represents subjective experiences of the plurality of users to the at least one sensory experience. In some embodiments, the plurality of responses may include a plurality of numerical data. Further, in some embodiments, the at least one input device may include a public input system. Further, in some embodiments, the at least one input device may include a plurality of user devices associated with the plurality of users. Further, in some embodiments, the at least one input device may include a plurality of wireless keypads associated with the plurality of users.

Further, at 306, the method 300 may include analyzing, using a processing device (such as the processing device 204), the plurality of responses.

Further, at 308, the method 300 may include calculating, using the processing device, a metric associated with the plurality of users based on the analyzing. Further, in some embodiments, the metric may include one or more of an average, a mean, a mode, an interquartile mean, a median, a standard deviation, a skewness and a kurtosis.

Further, at 310, the method 300 may include assigning, using the processing device, a plurality of scores to the plurality of users based on a comparison of the plurality of responses with the metric.

Further, at 312, the method 300 may include determining, using the processing device, at least one winner based on the scoring.

Further, at 314, the method 300 may include transmitting, using the communication device, indication of the at least one winner to the at least one presentation device.

Further, at 316, the method 300 may include storing, using a storage device (such as storage device 206), the plurality of responses in association with a plurality of identifiers associated with the plurality of users.

In some embodiments, the method 300 may further include receiving, using the communication device, a plurality of physiological responses from at least one physiological sensor comprised in the at least one input device. Further, the at least one physiological sensor may be configured for sensing the plurality of physiological responses associated with the plurality of users corresponding to at least one time corresponding to the delivery of the at least one sensory experience.

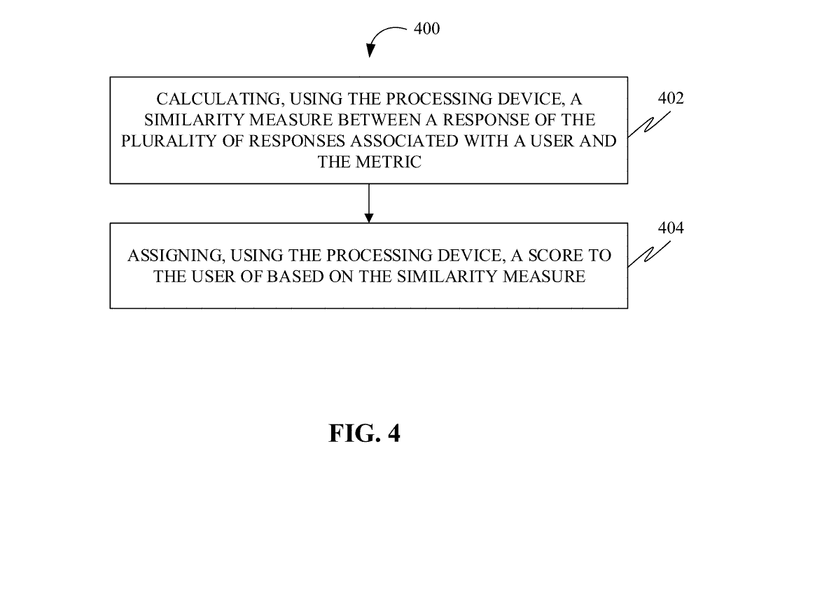

FIG. 4 is a flowchart of a method 400 to facilitate assigning score, in accordance with further embodiments. Accordingly, at 402, the method 400 may include calculating, using the processing device, a similarity measure between a response of the plurality of responses associated with a user and the metric.

Further, at 404, the method 400 may include assigning, using the processing device, a score to the user based on the similarity measure. Further, determining the at least one winner may include identifying a maximum score among the plurality of scores. Further, the maximum score corresponds to the at least one winner.

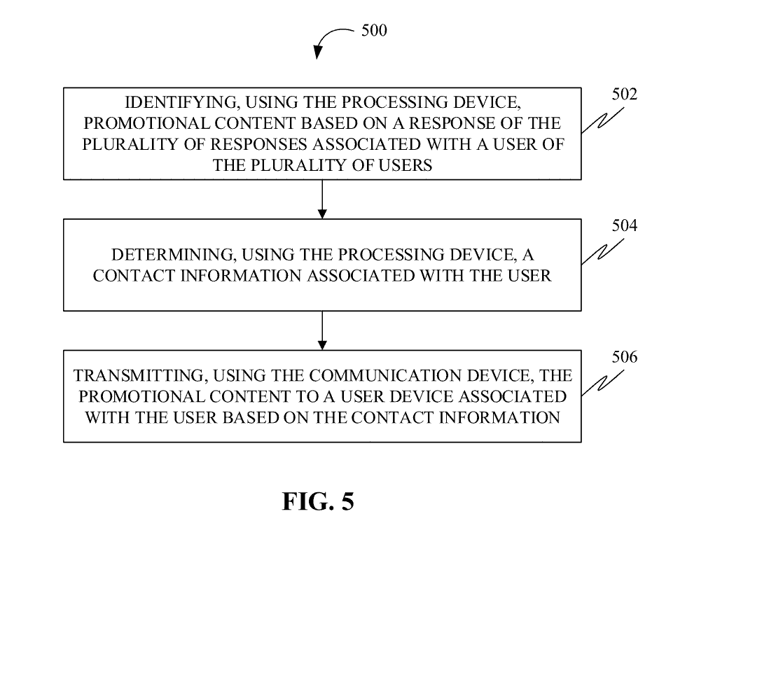

FIG. 5 is a flowchart of a method 500 to facilitate providing promotional content, in accordance with further embodiments. Accordingly, at 502, the method 500 may include identifying, using the processing device, promotional content based on a response of the plurality of responses associated with a user of the plurality of users.

Further, at 504, the method 500 may include determining, using the processing device, a contact information associated with the user.

Further, at 506, the method 500 may include transmitting, using the communication device, the promotional content to a user device associated with the user based on the contact information.

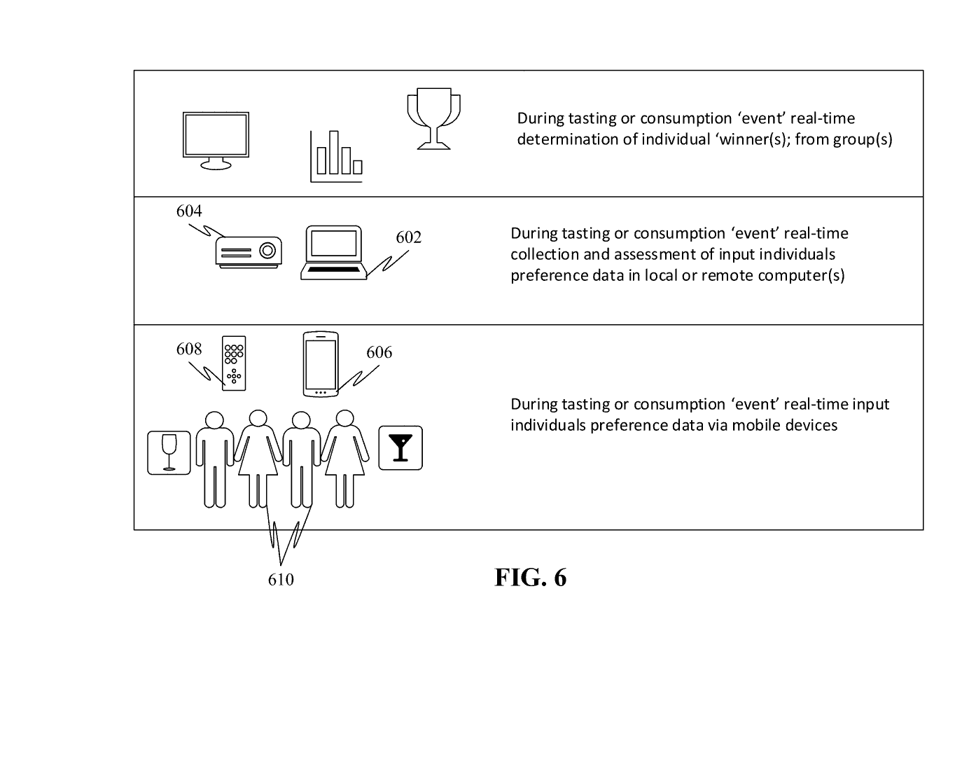

FIG. 6 is an exemplary schematic related to a tasting or consumption event, in accordance with an exemplary embodiment. As shown in FIG. 6, the online platform 100 may be employed for a real-time determination of individual ‘winner(s) from group(s) during a tasting or consumption event. Further, the online platform 100 may be employed for a real-time collection and assessment of input individuals’ preference data in local or remote computer(s) (such as, but not limited to, desktop computer 602, server computer 604 etc.) during tasting or consumption event. Moreover, the online platform 100 may be employed for a real-time input individuals' preference data via mobile devices (such as, but not limited to, smartphone 606, keyboard 608 etc.) during tasting or consumption event. For instance, users (such as individuals 610) may provide preference data by interacting with the smartphone 606 and/or keyboard 608 (e.g., by tapping a button on the keyboard 608, and/or by tapping on a screen of the smartphone 606) during tasting or consumption event.

According to some embodiments, a method for gamification of tasting events is disclosed. The method may include an organizer initiating an event, such as a tasting event for one or more food products. For example, the tasting event may be a wine tasting event. During tasting events, one or more users taste one or more food items, such as wines, tequilas, rums, vodkas, and whiskeys. The organizer may use the mobile device 104 (such as a smartphone, a laptop, a tablet computer etc.), other electronic devices 106 (such as desktop computers, server computers etc.) to access a web-based software application to initiate the event. Accordingly, the organizer may fill a form provided by the web-based software application to initiate the event. Further, the form may include fields such as name of the event, location of the event, rules of the event, details about the food item(s) for the event, rewards associated with the event.

In some embodiments, the organizer may organize the event for remotely located users. In some other embodiments, the organizer may organize the event for users located locally; for example, in a wine bar, a winery, a brewery, a restaurant and/or a house. Some wineries or breweries may also have a tasting room for organizing tasting events.

Further, the method may include the organizer inviting two or more users to participate in the tasting event. Accordingly, the organizer may invite the two or more users using the web-based software application. Therefore, the organizer may fill a form provided by the web-based software application to invite the two or more users. The form may include fields such as name of a user, address of the user, contact number of the user, and email of the user. Further, the tasting event, in an instance, may be a free event, wherein the two or more users may participate in the tasting event without paying any entry fee. In some embodiments, the tasting event may be a paid event, wherein the two or more users may participate in the tasting event after paying an entry fee.

Thereafter, the method may include sending invitation messages to the two or more users. Accordingly, the web-based software application may send the invitation messages to the two or more users. For example, the invitation messages may be sent via one or more of an SMS, an email, a call, a WhatsApp™ message, a Facebook Messenger™ message etc. Further, the invitation messages may include a link that may allow a user of the two or more users to access a web user interface (e.g. via a browser), which may allow the user to accept or reject the invitation. Alternatively, the two or more users may accept or reject the invitation by sending a reply via one or more of an SMS, an email, a call, a WhatsApp™ message, a Facebook Messenger™ message etc.

Further, the invitation message, in an instance, may include a link to install the web-based software application on the devices of the two or more users. Therefore, one or more of the two or more users may install the web-based software application on their devices. Moreover, the two or more users may accept or reject the invitation via the web-based software application installed on the devices associated with the two or more users. For example, the two or more users may accept or reject the invitation by using a user interface provided by the web-based software application.

Further, if the tasting event may be a paid event, the two or more users may pay the required entry fee through the user interface provided by the web-based software application to accept the invitation.

In some embodiments, one or more users in the two or more users may participate in the tasting event without receiving an invitation. Accordingly, the one or more users may directly visit the venue of the tasting event or may register online.

Thereafter, the method may include the users in the two or more users that accepted the invitation to procure and taste the one or more food items. Further, the remotely located users may procure the one or more food products from market. Alternatively, the organizer may send the one or more food products to the remotely located users. The users located locally may taste the one or more food products available at the event location. For example, the one or more food products may be arranged on a table allowing the visiting users to taste the one or more food products.

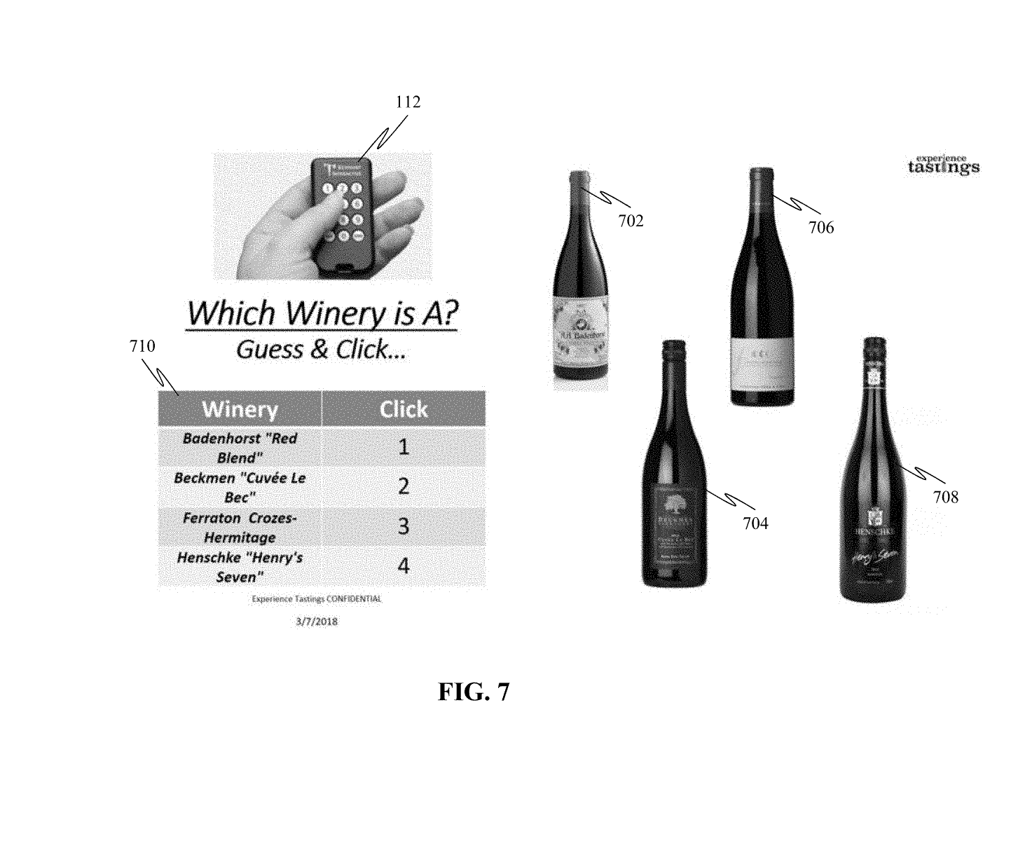

Thereafter, the users participating in the event may vote for the one or more food products. The users may vote using their devices via the web-based software application. Further, the web-based software application may timestamp the votes and store voting information. The voting information may include one or more identity of the respective user, the vote casted and the timestamp. Further, the users may be provided the wireless keypads 112 to vote for the one or more food products. The wireless keypads 112 may include one or more buttons to allow the users to vote. For example, the wireless keypads 112 may include 5-12 buttons. Further, the wireless keypads 112 may internally timestamp the votes and store the voting information. The voting may be explained in further detail in conjunction with FIG. 7 to FIG. 12 below. Further, the method may collect data/preferences by engaging the users proactively throughout the tasting process.

In a further embodiment, the voting may include measuring one or more physiological parameters of a user while the user tastes a food product. The physiological parameters may be measured using sensors, such as the sensors 110 and/or the physiological sensor 118. For example, the one or more physiological parameters may include body temperature, heart rate, respiratory rate, blood pressure, emotions (e.g. facial expressions, body language and so on) etc. Accordingly, a physiological parameter of a user may be measured during and/or immediately after the user tastes a food product. In an embodiment, the physiological parameter may be used in conjunction with a corresponding vote provided by a user. For example, the vote corresponding to the user may be combined with the physiological parameter in order to determine a composite vote for the user. In another embodiment, the physiological parameter of the user may itself represent the vote.

The web-based software application installed on the devices of the users may be configured to transmit the voting information to the device of the organizer. Further, the wireless keypads 112 may transmit the voting information to the device of the organizer. The wireless keypads 112 may communicate with the device of the organizer via one or more of a Bluetooth™, ZigBee′, Wi-Fi, TCP/IP etc. Further, the wireless keypads 112 may communicate over 2.4 GHz radio frequency. Further, the votes may be transmitted over the online platform 100. The wireless keypads 112 may be powered via rechargeable or non-rechargeable batteries.

Next, the method may include receiving the voting information at the device of the organizer. Therefore, the device of the organizer may include a transceiver to receive the voting information. For example, the transceiver may be plugged into the device of the organizer. The transceiver may support multiple communication channels for large groups of users.

Further, the method may include analyzing the voting information received from the users participating in the event. The data analysis may be performed in real-time. The analysis may include identifying one or more winners based on the rules of the tasting event. Further, the one or more winners may be rewarded in real-time. The analysis may involve one or more of predefined algorithms, Artificial Intelligence (AI) and machine learning.

In an exemplary embodiment, the one or more food products may include six wines. Therefore, the users participating in the event may taste each of the six wines and then vote. For example, the users may give a voting score of 1-10 for each wine. Alternatively, the users may rank each wine from 1-6. Similarly, the vote may include any objective parameter assigned by the users to the one or more food products. Thereafter, the analysis may include calculating an average voting score for each wine for all the users participating in the event. Further, the analysis may involve calculating the deviation between voting score given by each user for each wine and the average voting score for the all the users for each wine. The user with the least deviation may be selected as a winner. The winner may be considered to be representative of the group taste for all the users participating in the event. Accordingly, the winner may be give a gold star. Further, one or more users with the second least deviation may be selected as a second winner and so on.

In another exemplary embodiment, the one or more food products may include six wines. Therefore, the users participating in the event may taste each of the six wines and then vote. For example, the users may give a voting score of 1-10 for each wine. Further, one or more connoisseurs may taste each of the six wines and then vote. Further, the analysis may involve calculating an average voting score for each wine for all the connoisseurs participating in the event. Thereafter, the analysis may involve calculating the deviation between voting score given by each user for each wine and the average voting score for all the connoisseurs for each wine. The user with the least deviation may be selected as a winner.

In a further embodiment, the one or more of the average voting score for the all the users for each wine and the average voting score for the all the connoisseurs for each wine may be used to dynamically change the price of the wines. Therefore, the price of wines may be updated in pricing databases, such as included in databases 108. For example, the tasting event may be organized in a bar, wherein the price of the wines which receive higher voting scores from the users/connoisseurs may be increased dynamically automatically.

In a further embodiment, the event may include allowing the users/connoisseurs to vote for one or more categories including taste, smell and texture of the one or more food products. Accordingly, the winners may be determined in each category.

The data including voting scores, the analyzed voting scores, and the selected winners may be stored on the online platform 100. The data may be made available to the wineries/distributors/consumers.

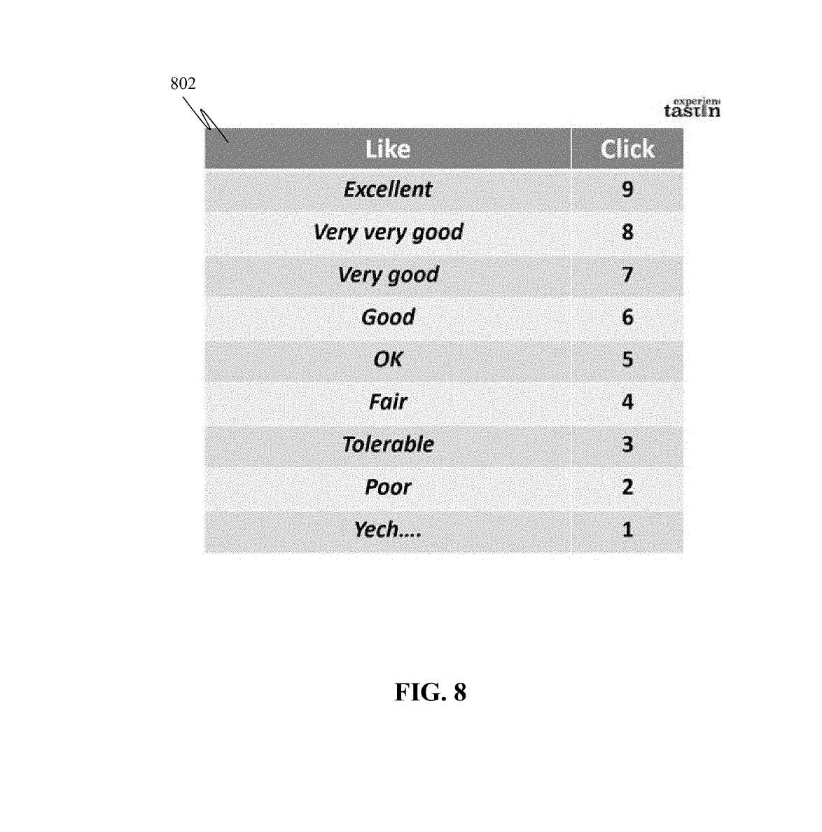

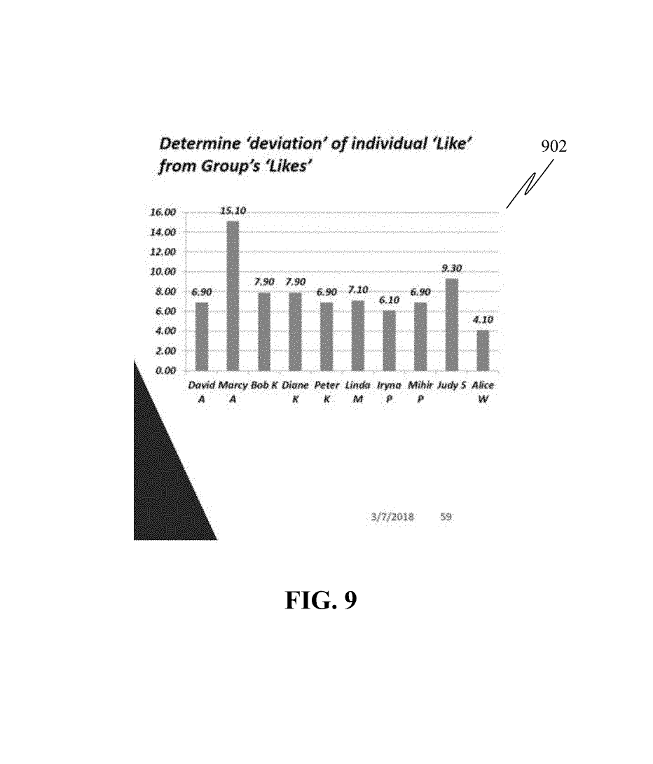

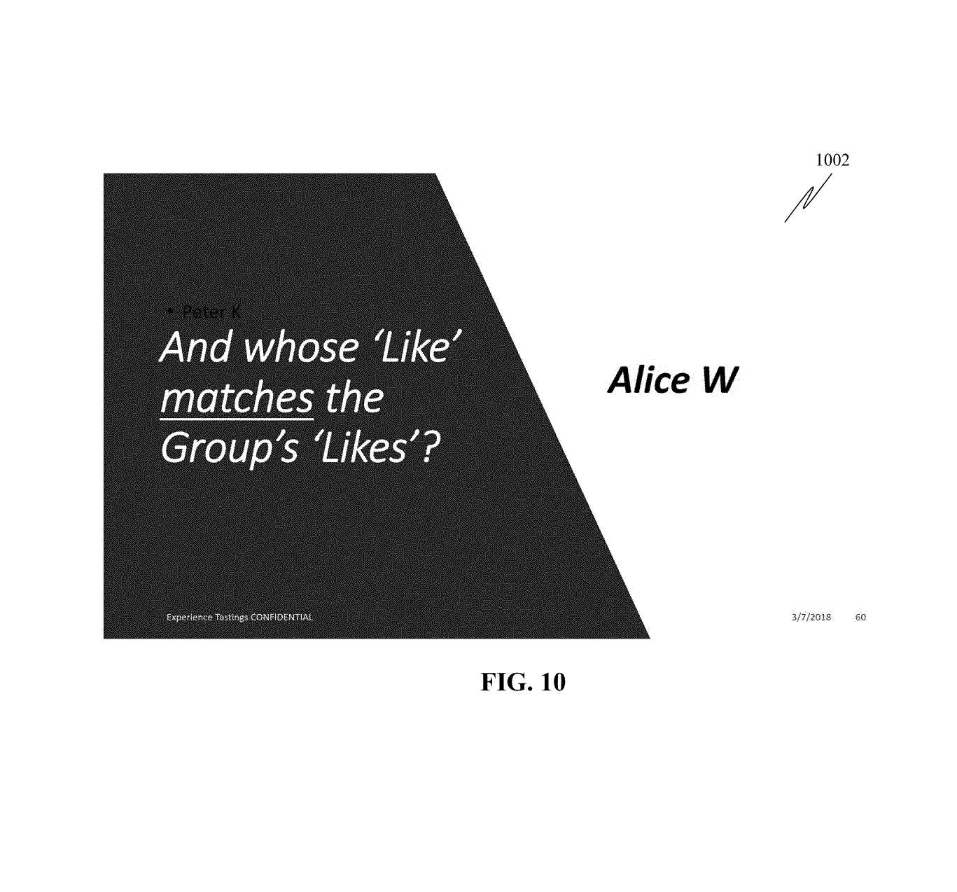

FIG. 7 is a schematic related to a wine tasting event, in accordance with an exemplary embodiment. Further, FIG. 8 is an exemplary representation of a note card presented to a user at a wine tasting event, in accordance an exemplary embodiment. Further, FIG. 9 is an exemplary representation of a deviation scorecard, in accordance with some embodiments. Further, FIG. 10 is an exemplary representation of a winner card, in accordance with some embodiments.

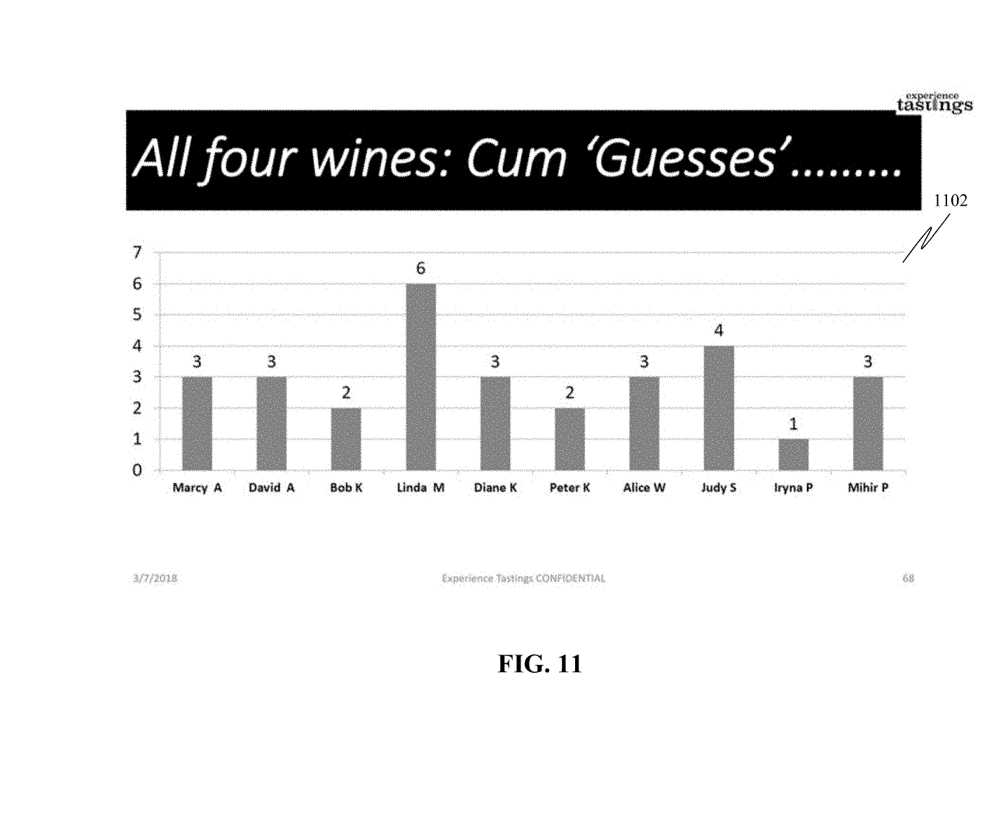

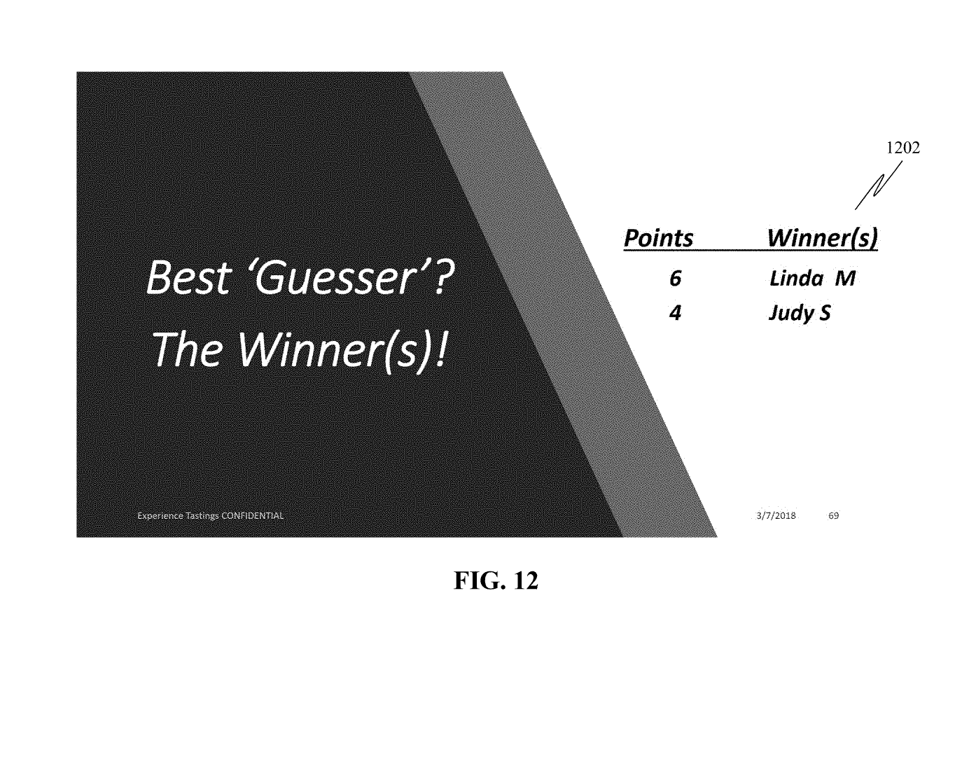

FIG. 11 is an exemplary representation of a guess scorecard, in accordance with some embodiments. Further, FIG. 12 is an exemplary representation of a winner card, in accordance with some embodiments.

Accordingly, the wine tasting event may allow users/participants to taste wines, guess wines, like wines and/or win prizes accordingly. For example, the users may have to guess one or more of a winery, a region and/or a price of one or more wines the user may taste at the event. The users with the most correct answers, in an instance, may be chosen as winners. Further, as shown in FIG. 7, the wine tasting event may include a blind tasting contest, wherein the users may taste 4 wines from 4 different wineries respectively. For example, the 4 different wineries may include Badenhorst “Red Blend” ™ 702, Beckmen “Cuvee Le Bec” ™ 704, Ferraton Crozes-Hermitage™ 706, and Henschke “Henry's Seven”™ 708. Further, the user, in an instance, may be presented a note card 710 that may reflect instructions to be followed by the user to vote in order to indicate the winery. Further, the note card 710, in an instance, may be in a physical form and/or a virtual form. Further, the physical form of the note card 710, in an instance, may be a tangible and/or observable form of the note card 710 that may be felt and/or observed by the user at the wine tasting event. For instance, the physical form may include, but not limited to, a paper card that may be presented to the user physically at the wine tasting event. Further, the virtual form of the note card 710, in an instance, may be an intangible form of the note card 710 that may be presented to the user at the wine tasting event through a presentation device, such as the presentation device 208. The presentation device, in an instance, may include, but may not be limited to, a television (TV), a laptop, a smartphone, a smartwatch etc. Accordingly, the user may taste each of the 4 wines one-by-one and vote (as instructed in the note card 710) to indicate the winery. For example, the user may click 1 on the wireless keypad 112 to indicate that the wine is from the winery Badenhorst “Red Blend”™ 702. Further, the user may click 2 on the wireless keypad 112 to indicate that the wine is from the winery Beckmen “Cuvee Le Bec”™ 704. Further, the user may click 3 on a wireless keypad 112 to indicate that the wine is from the winery Ferraton Crozes-Hermitage™ 706. Further, the user may click 4 on a wireless keypad 112 to indicate that the wine is from the winery Henschke “Henry's Seven” ™ 708.

Further, as shown in FIG. 8, a note card 802 may be presented to the user (such as in the physical form and/or the virtual form) at the wine tasting event which may reflect instruction to allow the users to rate each wine as one of the “excellent,” “very very good,” “very good,” “good,” “ok,” “fair,” “tolerable,” “poor” and “yech” etc. For example, the user may click 9 on the wireless keypad 112 to indicate that the wine is “excellent”. Further, the user may click 8 on the wireless keypad 112 to indicate that the wine is “very very good”. Further, the user may click 7 on the wireless keypad 112 to indicate that the wine is “very good.” Further, the user may click 6 on the wireless keypad 112 to indicate that the wine is “good.” Further, the user may click 5 on the wireless keypad 112 to indicate that the wine is “ok.” Further, the user may click 4 on the wireless keypad 112 to indicate that the wine is “fair.” Further, the user may click 3 on the wireless keypad 112 to indicate that the wine is “tolerable.” Further, the user may click 2 on the wireless keypad 112 to indicate that the wine is “poor.” Further, the user may click 1 on the wireless keypad 112 to indicate that the wine is “yech.” Further, the voting information may be received and/or analyzed by the online platform 100 to compile results. Further, the voting information, in an instance, may include the numbers clicked by each user on each wireless keypad 112.

In some embodiments, the online platform 100 may be configured to determine (using the processing device 204) a group average voting score for each wine. Further, the online platform 100 may be configured for calculating (using the processing device 204) deviations between the user's voting score and the group average voting score for each wine. Further, the deviations for a single user may be added to obtain an overall deviation for the user. Further, the overall deviation for each user, in an instance, may be visually represented to an administrator through a deviation scorecard 902 as shown in FIG. 9. Further, the deviation scorecard 902, in an instance, may be a graphical representation (such as a bar graph) that may display the overall deviation for each user at the wine tasting event. Further, the deviation scorecard 902, in an instance, may be used by the administrator (and/or the online platform 100) to identify a winner whose voting score may be closest to the group average voting score (for example, a user with the least overall deviation as represented in the deviation scorecard 902). For example, 10 users may participate in the wine tasting event. The 10 users may include “David A”, “Marcy A”, “Bob K”, “Diane K”, “Peter K”, “Linda M”, “Iryna P”, “Mihir P”, “Judy S, Alice W”, as shown in FIG. 9. The overall deviation for the user “David A” may be 6.9. Further, the overall deviation for the user “Marcy A” may be 15.10. Further, the overall deviation for the user “Bob K” may be 7.90. Further, the overall deviation for the user “Diane K” may be 7.90. Further, the overall deviation for the user “Peter K” may be 9.90. Further, the overall deviation for the user “Linda M” may be 7.10. Further, the overall deviation for the user “Iryna P” may be 6.10. Further, the overall deviation for the user “Mihir P” may be 6.90. Further, the overall deviation for the user “Judy S” may be 9.30. Further, the overall deviation for the user “Alice W” may be 4.10.

Further, the user with the least overall deviation from the group average may be chosen as the winner. Accordingly, a winner card 1002, as shown in FIG. 10, may be generated by the online platform 100. For instance, the winner card 1002 may include the name of the user with the least overall deviation (e.g. the user “Alice W” with the deviation of 4.10 may be chosen the winner). Further, the winner card 1002, in an instance, may be presented to the winner in a physical form and/or in a virtual form. Further, the physical form, in an instance, may be a tangible and/or observable form of the winner card 1002 that may be felt and/or observed by the winner at the wine tasting event. For instance, the physical form may include, but not limited to, a paper card that may be presented to the winner physically at the wine tasting event. Further, the virtual form of the winner card 1002, in an instance, may be an intangible form of the winner card 1002 that may be presented to the winner at the wine tasting event through a presentation device. The presentation device, in an instance, may include, but not limited to, a television (TV), a laptop, a smartphone, a smartwatch etc.

Similarly, a “guess score card 1102” may be generated by the online platform 100, which may include a “guessing” score obtained from the 10 users, as shown in FIG. 11. Further, the guessing score may include information related to guesses made by the respective users for the 4 wines. For example, the overall guessing score for the user “Marcy A” may be 3. Further, the overall guessing score for the user “David A” may be 3. Further, the overall guessing score for the user “Bob K” may be 2. Further, the overall guessing score for the user “Linda M” may be 6. Further, the overall guessing score for the user “Diane K” may be 3. Further, the overall guessing score for the user “Peter K” may be 2. Further, the overall guessing score for the user “Alice W” may be 3. Further, the overall guessing score for the user “Judy S” may be 4. Further, the overall guessing score for the user “Iryna P” may be 1. Further, the overall guessing score for the user “Mihir P” may be 3.

Further, the guess scorecard 1102, in an instance, may be a graphical representation (such as a bar graph) that may display the overall guessing score for each user at the wine tasting event. Further, the guess scorecard 1102, in an instance, may be used by the administrator (and/or the online platform 100) to identify a one or more of winners whose guessing score may be highest from the rest of the users. For example, a user with the highest guessing score may be chosen as a winner. Accordingly, a winner card 1202, as shown in FIG. 12, may be generated by the online platform 100, which may include the name of the user with the highest guessing score (e.g. the user “Linda M” with the guessing score of 6 may be chosen as the winner.). Further, the winner card 1202, in an instance, may also include the name of the user with the second highest guessing score (e.g. the user “Judy S” with the guessing score of 4 may be chosen as the second winner.).

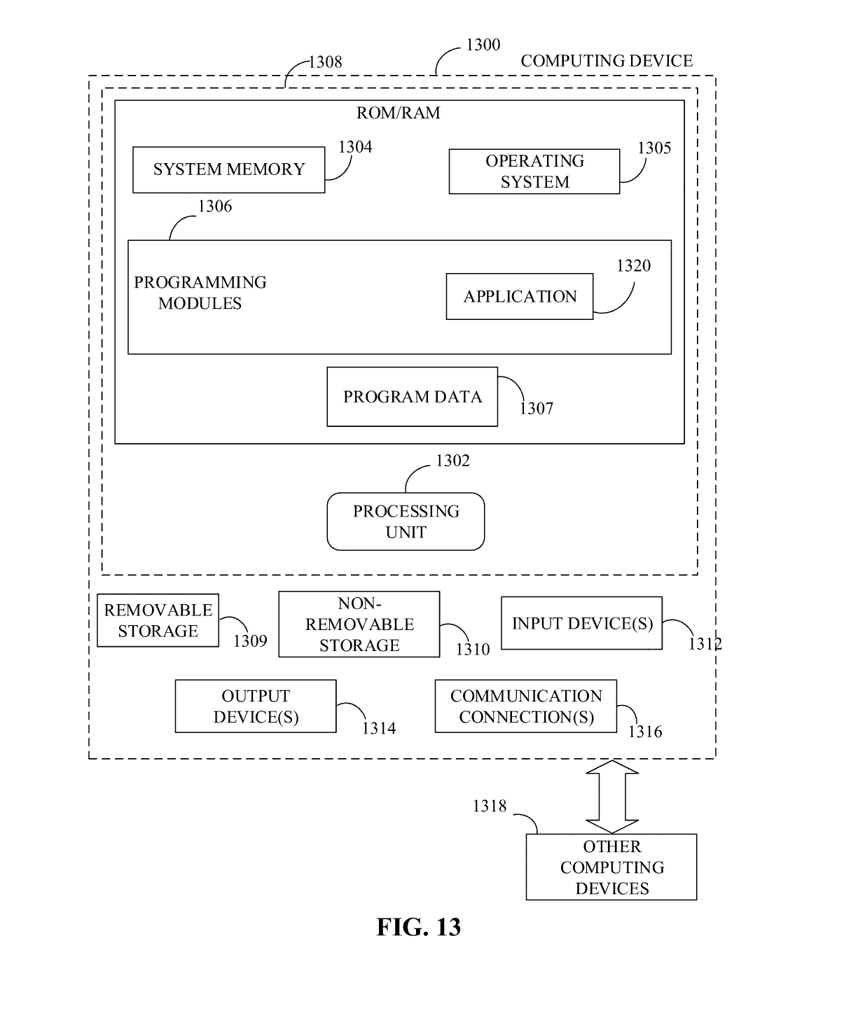

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random-access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306 may include image-processing module, machine learning module. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and non-volatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, a location sensor, a camera, a biometric sensor, etc. Output device(s) 1314 such as a display, speakers, a printer, etc. may also be included. The aforementioned devices are examples and others may be used.

Computing device 1300 may also contain a communication connection 1316 that may allow computing device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 (e.g., application 1320 such as a media player) may perform processes including, for example, one or more stages of methods, algorithms, systems, applications, servers, databases as described above. The aforementioned process is an example, and processing unit 1302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of collecting subjective preferences from users using gamification, the method comprising:
transmitting, using a communication device, at least one prompt to at least one presentation device configured for presenting the at least one prompt, wherein the at least one prompt is associated with at least one sensory experience deliverable to a plurality of users;
receiving, using the communication device, a plurality of responses from at least one input device associated with the plurality of users, wherein the plurality of responses represents subjective experiences of the plurality of users to the at least one sensory experience;
analyzing, using a processing device, the plurality of responses;
calculating, using the processing device, a metric associated with the plurality of users based on the analyzing;
assigning, using the processing device, a plurality of scores to the plurality of users based on a comparison of the plurality of responses with the metric;
determining, using the processing device, at least one winner based on the scoring;
transmitting, using the communication device, indication of the at least one winner to the at least one presentation device; and
storing, using a storage device, the plurality of responses in association with a plurality of identifiers associated with the plurality of users.

2. The method of claim 1, wherein the at least one presentation device comprises a public presentation system.

3. The method of claim 1, wherein the at least one presentation device comprises a plurality of user devices associated with the plurality of users.

4. The method of claim 1, wherein the at least one input device comprises a public input system.

5. The method of claim 1, wherein the at least one input device comprises a plurality of user devices associated with the plurality of users.

6. The method of claim 1, wherein the at least one input device comprises a plurality of wireless keypads associated with the plurality of users.

7. The method of claim 1, wherein the plurality of responses comprises a plurality of numerical data, wherein the metric comprises at least one of an average, a mean, a mode, an interquartile mean, a median, a standard deviation, a skewness and a kurtosis.

8. The method of claim 1, wherein the assigning comprises:
calculating, using the processing device, a similarity measure between a response of the plurality of responses associated with a user and the metric; and
assigning, using the processing device, a score to the user of based on the similarity measure, wherein determining the at least one winner comprises identifying a maximum score among the plurality of scores, wherein the maximum score corresponds to the at least one winner.

9. The method of claim 1 further comprising receiving, using the communication device, a plurality of physiological responses from at least one physiological sensor comprised in the at least one input device, wherein the at least one physiological sensor is configured for sensing the plurality of physiological responses associated with the plurality of users corresponding to at least one time corresponding to the delivery of the at least one sensory experience.

10. The method of claim 1 further comprising:
identifying, using the processing device, promotional content based on a response of the plurality of responses associated with a user of the plurality of users;
determining, using the processing device, a contact information associated with the user; and
transmitting, using the communication device, the promotional content to a user device associated with the user based on the contact information.

11. A system for collecting subjective preferences from users using gamification, the system comprising:
a communication device configured for:
transmitting at least one prompt to at least one presentation device configured for presenting the at least one prompt, wherein the at least one prompt is associated with at least one sensory experience deliverable to a plurality of users;
receiving a plurality of responses from at least one input device associated with the plurality of users, wherein the plurality of responses represents subjective experiences of the plurality of users to the at least one sensory experience;
transmitting indication of the at least one winner to the at least one presentation device;
a processing device configured for:
analyzing the plurality of responses;
calculating a metric associated with the plurality of users based on the analyzing;
assigning a plurality of scores to the plurality of users based on a comparison of the plurality of responses with the metric;
determining at least one winner based on the scoring; and
a storage device configured for storing the plurality of responses in association with a plurality of identifiers associated with the plurality of users.

12. The system of claim 11, wherein the at least one presentation device comprises a public presentation system.

13. The system of claim 11, wherein the at least one presentation device comprises a plurality of user devices associated with the plurality of users.

14. The system of claim 11, wherein the at least one input device comprises a public input system.

15. The system of claim 11, wherein the at least one input device comprises a plurality of user devices associated with the plurality of users.

16. The system of claim 11, wherein the at least one input device comprises a plurality of wireless keypads associated with the plurality of users.

17. The system of claim 11, wherein the plurality of responses comprises a plurality of numerical data, wherein the metric comprises at least one of an average, a mean, a mode, an interquartile mean, a median, a standard deviation, a skewness and a kurtosis.

18. The system of claim 11, wherein the processing device is further configured for:
calculating a similarity measure between a response of the plurality of responses associated with a user and the metric; and
assigning a score to the user of based on the similarity measure, wherein determining the at least one winner comprises identifying a maximum score among the plurality of scores, wherein the maximum score corresponds to the at least one winner.

19. The system of claim 11 further comprising receiving a plurality of physiological responses from at least one physiological sensor comprised in the at least one input device, wherein the at least one physiological sensor is configured for sensing the plurality of physiological responses associated with the plurality of users corresponding to at least one time corresponding to the delivery of the at least one sensory experience.

20. The system of claim 11, wherein the processing device is further configured for:
identifying promotional content based on a response of the plurality of responses associated with a user of the plurality of users;
determining a contact information associated with the user, wherein the communication device is further configured for transmitting the promotional content to a user device associated with the user based on the contact information.
